(19) United States
(12) Patent Application Publication
(10) Pub. No.: US 2011/0117892 A1
(43) Pub. Date: May 19, 2011

(54) METHOD OF REALIZING AUTOMATIC DIAL-UP CONNECTION TO INTERNET FROM COMPUTER AND COMMUNICATION DEVICE USING THE SAME

(75) Inventors: Shan-Liang Wang, Shanghai City (CN); Bing-Hao Fan, Shanghai City (CN); Yu-Lung Shen, Taipei (TW)

(73) Assignee: INVENTEC APPLIANCES CORP., Taipei (TW)

(21) Appl. No.: 12/687,359

(22) Filed: Jan. 14, 2010

(30) Foreign Application Priority Data
Nov. 19, 2009 (TW) 98139334

(51) Int. Cl. H04M 3/42

(52) U.S. Cl. 455/414.1

(57) ABSTRACT

A method of realizing an automatic dial-up connection to Internet from a computer and a communication device using the same are provided. The method is suitable for connecting the computer to Internet through a communication device, and the method includes the following steps. A procedure of automatic dial-up connection to Internet is composed, where the automatic dial-up connection procedure includes a user data. A compact disc image file is produced according to the automatic dial-up connection procedure, and the compact disc image file includes an automatic installation procedure. The compact disc image file is burned into the communication device, and when the communication device is connected to the computer, the computer executes the automatic dial-up connection procedure by performing the automatic installation procedure, in order to make a dial-up connection to Internet.

### CROSS-REFERENCE TO RELATED APPLICATION

This application claims the priority benefit of Taiwan application serial no. 98139334, filed Nov. 19, 2009. The entirety of the above-mentioned patent application is hereby incorporated by reference herein and made a part of specification.

### BACKGROUND OF THE INVENTION

1. Field of the Invention

The invention generally relates to a method of realizing an automatic dial-up connection to Internet from a computer, and more particularly, to a method of an automatic dial-up connection to Internet from a computer and a communication device using the same.

2. Description of Related Art

Nowadays, wireless communication networks have been broadly deployed. Besides going online by directly using a mobile phone, a user may also connect to Internet through a mobile phone or a wireless data network card by using a computer. However, most wireless communication network usually require users to set up a specific Internet connection procedure (for example, input specific username and password) in the computer. The user needs to read a manual of the mobile phone or the wireless data network card carefully in order to set up Internet connection procedure. Once the manual is lost or the user forgets the specific username or password, the user cannot connect to Internet through the mobile phone or the wireless data network card by using the computer. Accordingly, techniques of connecting to Internet through a mobile phone or a wireless communication network by using a computer is too complicated and inconvenient to use currently.

### SUMMARY OF THE INVENTION

According to exemplary embodiments of the invention, a method of realizing an automatic dial-up connection to Internet from a computer and a communication device using the same are provided. In the present method, a compact disc image file is virtually composed in a communication device, where the compact disc image file includes an automatic installation procedure and an automatic dial-up connection procedure. After the computer and the communication device establish a wired connection and complete a handshaking procedure, the computer reads the automatic installation procedure from the compact disc image file in the communication device and executes an automatic dial-up connection by performing the automatic installation procedure. Thus, a user does not need manually setting up any dial-up connection procedure in the computer when the user needs using Internet so that complexity of the operation is lowered.

According to an exemplary embodiment of the invention, a method of realizing an automatic dial-up connection to Internet from a computer is provided. The method is suitable for connecting the computer to Internet through a communication device, and the method includes the following steps. A procedure of automatic dial-up connection to Internet is composed, where the automatic dial-up connection procedure includes a user data. A compact disc image file is produced according to the automatic dial-up connection procedure, and the compact disc image file includes an automatic installation procedure. The compact disc image file is burned into the communication device, and when the communication device is connected to the computer, the computer executes the automatic dial-up connection procedure by performing the automatic installation procedure, in order to make a dial-up connection to Internet.

According to an exemplary embodiment of the invention, a communication device is provided, suitable for realizing an automatic dial-up connection to Internet from a computer via the communication device to connect the computer to Internet. The communication device includes a communication network interface, a wired connection interface and a memory unit. The communication network interface establishes a dial-up connection to Internet. The wired connection interface establishes a wired connection with the computer. The memory unit stores a compact disc image file, where the compact disc image file includes an automatic installation procedure. When the communication device is connected to the computer, the computer executes an automatic dial-up connection procedure by performing the automatic installation procedure, in order to make a dial-up connection to Internet.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a method of realizing an automatic dial-up connection to Internet from a computer via a wireless communication device according to an exemplary embodiment of the invention.

FIG. 2 is a schematic block diagram illustrating a method of realizing an automatic dial-up connection to Internet from a computer via a wireless communication device according to another exemplary embodiment of the invention.

FIG. 3 is a flowchart illustrating a method of realizing an automatic dial-up connection to Internet from a computer via a wireless communication device according to an exemplary embodiment of the invention.

FIG. 4 is a flowchart illustrating a method of realizing an automatic dial-up connection to Internet from a computer via a wireless communication device according to another exemplary embodiment of the invention.

FIG. 5 is a schematic diagram illustrating how a computer and a wireless communication device exchange SCSI commands according to an exemplary embodiment of the invention.

FIG. 6 is a schematic block diagram illustrating a method of realizing an automatic dial-up connection to Internet from a computer via a communication device according to another exemplary embodiment of the invention.

FIG. 7 is a flowchart illustrating a method of realizing an automatic dial-up connection to Internet from a computer via a communication device according to another exemplary embodiment of the invention.

FIG. 8 is a schematic diagram illustrating how a computer and a communication device exchange SCSI commands according to another exemplary embodiment of the invention.

### DESCRIPTION OF THE EMBODIMENTS

Reference will now be made in detail to the present exemplary embodiments of the invention, examples of which are illustrated in the accompanying drawings. Wherever possible, the same reference numbers are used in the drawings and the description to refer to the same or like parts.

According to exemplary embodiments of the invention, a method of realizing an automatic dial-up connection to Internet from a computer and an apparatus thereof are provided. The method includes the following steps. A compact disc image file is produced in a memory unit of a communication device, where the compact disc image file includes an automatic installation procedure and an automatic dial-up connection procedure. After the computer and the communication device establish a wired connection and complete a handshaking procedure, the computer reads the automatic installation procedure from the compact disc image file in the communication device and performs the automatic installation procedure to accomplish an automatic dial-up connection functionality. Accordingly, a user does not need manually setting up any dial-up connection procedure in the computer when the user needs using Internet.

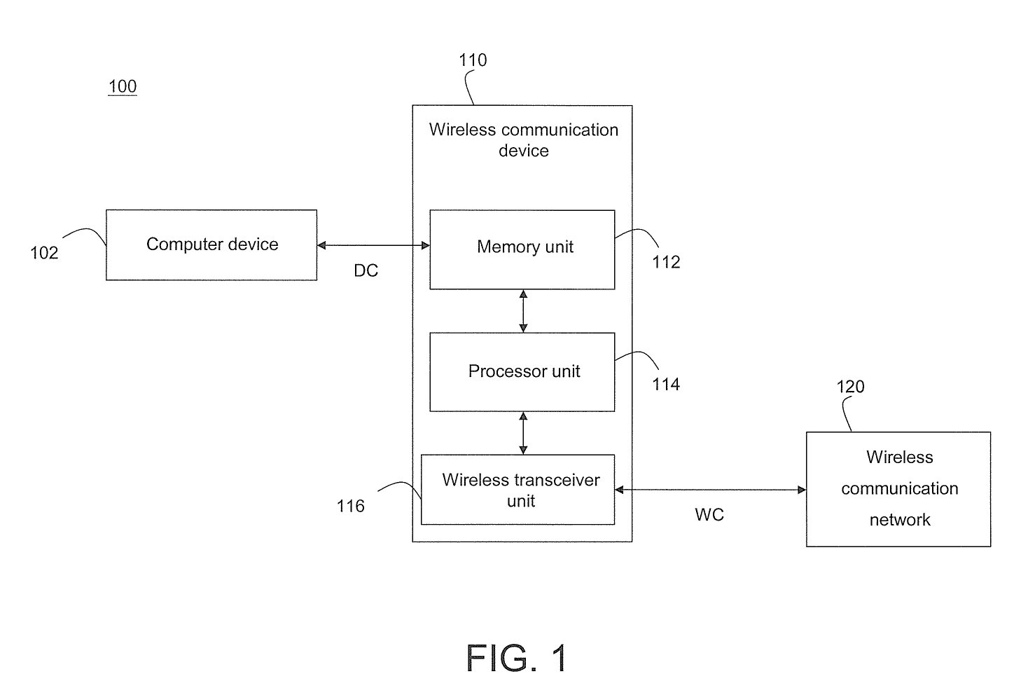

FIG. 1 is a schematic block diagram illustrating a method of realizing an automatic dial-tip connection to Internet from a computer via a wireless communication device according to an exemplary embodiment of the invention. Referring to FIG. 1, the computer device 102 establishes a connection with a wireless communication device 110 via a wired connection DC. The wireless communication device 110 includes a memory unit 112, a processor unit 114, a wireless transceiver unit 116, and a wired connection interface (not shown). In addition, the wireless communication device 110 establishes a wireless connection WC with a wireless communication network 120 through the wireless transceiver unit 116.

Referring to FIG. 1, the wireless communication device 110 establishes the wired connection DC with the computer device 102 through the wired connection interface, and the computer device 102 has a corresponding wired connection interface. In the present exemplary embodiment, the wired connection interface used by the wireless communication device 110 and the computer device 102 may be a universal serial bus (USB) interface. The computer device 102 can carry out a wired data transmission with the wireless communication device 110 by USB interface enumeration. However, the invention is not limited thereto, and in other embodiments of the invention, the wired connection interfaces used by the wireless communication device 110 and the computer device 102 are, for example, peripheral component interconnect express (PCIe) interfaces and Personal Computer Memory Card International Association (PCMCIA) interfaces, etc. Besides, in the present exemplary embodiment, the wireless communication device 110 may be a mobile phone or a wireless data network card. In other embodiments of the invention, the wireless communication device 110 and the computer device 102 may also be integrated.

In the present exemplary embodiment, the memory unit 112 stores a program module. The program module executes one or multiple procedures for generating medium programs when the program module is executed by the processor unit 114. Besides, the memory unit 112 may be one or multiple memory devices adapted for storing data and software programs, and the memory unit 112 includes a predetermined storage area (not shown). In the present exemplary embodiment, the memory unit 112 may be a FLASH memory device. However, the invention is not limited thereto, and in another embodiment of the invention, the memory unit 112 is, for example, one or a combination of magnetic storage equipments and optical storage equipments.

In the present exemplary embodiment, the predetermined storage area in the memory unit 112 contains an automatic dial-up connection procedure. Accordingly, the computer device 102 can execute the automatic dial-up connection procedure to connect the wireless communication device 110 to the wireless communication network 120 by performing an automatic installation procedure, in order to make a dial-up connection to Internet, so as to connect the computer to Internet. The automatic dial-up connection procedure includes a user data, where the user data includes a predetermined legitimate username, a predetermined legitimate password, and a predetermined legitimate dial-up connection option. When the computer device 102 performs the automatic dial-up connection procedure, the wireless communication device 110 provides the predetermined legitimate username, the predetermined legitimate password, and the predetermined legitimate dial-up connection option to the wireless communication network 120 to perforin an authentication procedure. In the present exemplary embodiment, for example, the wireless communication network 120 may be a wireless communication network adopting the CDMA2000 system, the predetermined legitimate username may be “card”, the predetermined legitimate password may also be “card”, and the predetermined legitimate dial-up connection option may be “#777”. However, the invention is not limited thereto, and in another embodiment of the invention, the predetermined legitimate username, the predetermined legitimate password, and the predetermined legitimate dial-up connection option may also be other text strings, and the predetermined legitimate username may be different from the predetermined legitimate password. Besides, the processor unit 114 controls the wireless transceiver unit 116, the wired connection interface, and the memory unit 112.

In the present exemplary embodiment, the automatic dial-up connection procedure includes a first file, a second file, and a third file. The filename extension of the first file includes “.exe,” the filename extension of the second file includes “.dat,” and the third file includes a file “autorun.inf.” When the computer device 102 performs the automatic installation procedure, the computer device 102 calls the first file according to the third file so as to complete the automatic dial-up connection procedure.

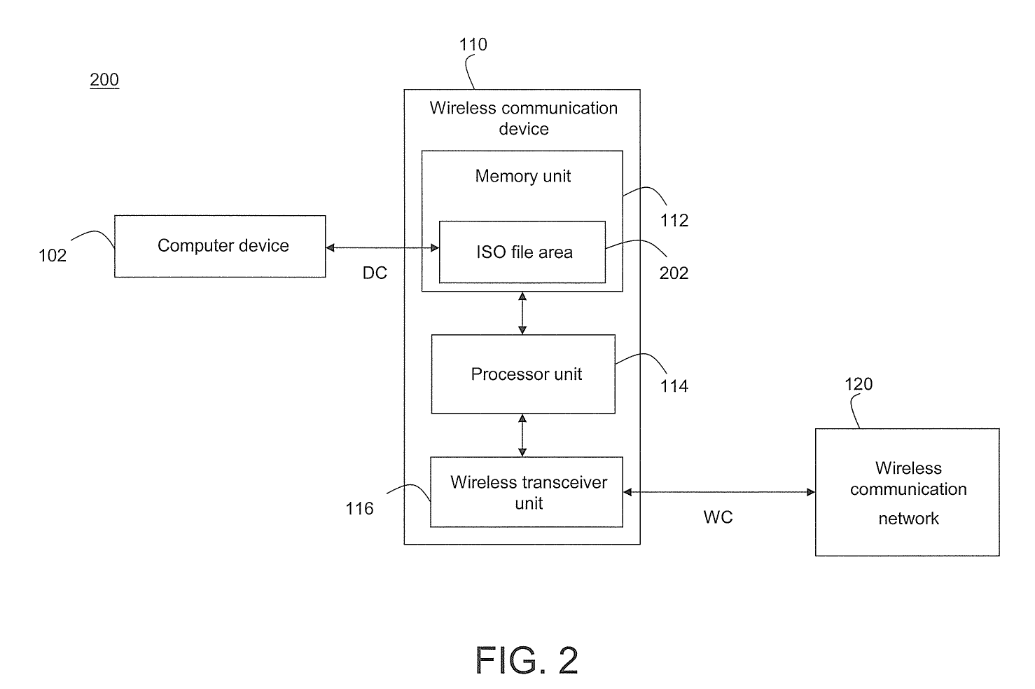

FIG. 2 is a schematic block diagram illustrating a method of realizing an automatic dial-up connection to Internet from a computer via a wireless communication device according to another exemplary embodiment of the invention. Referring to FIG. 2, in the present exemplary embodiment, the system 200 illustrated in FIG. 2 is similar to the system 100 illustrated in FIG. 1, and the only difference between the system 100 and the system 200 is that, in the system 200, the predetermined storage area of the memory unit 112 is configured to be conformed to a standard established by the International Organization for Standardization (ISO). To be more specific, the predetermined storage area includes a compact disc image file (not shown), where the compact disc image file is configured to be conformed to the ISO9660 standard and is virtualized to work as a compact disc device driven by the computer device 102, and the compact disc image file is stored in an ISO file area 202. In other words, the automatic dial-up connection procedure is converted into a compact disc data storage structure, which conforms to an ISO9660 standard.

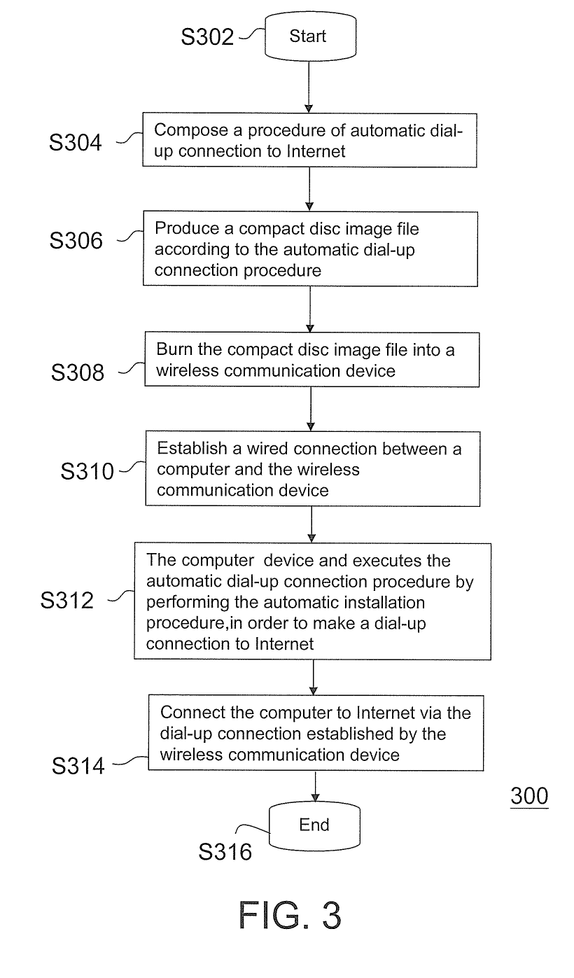

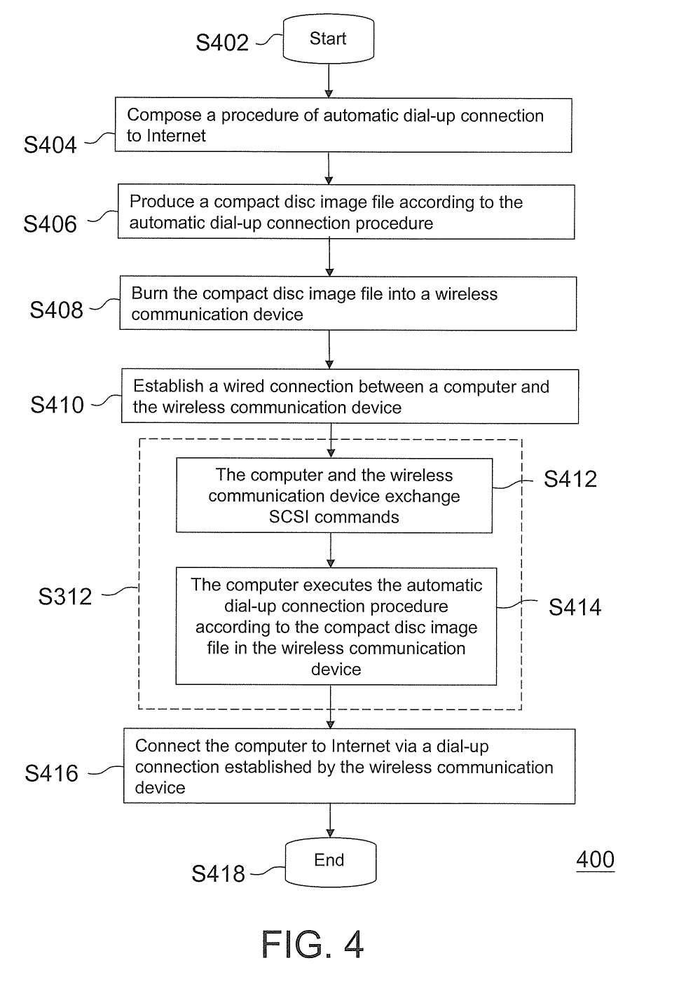

In the present exemplary embodiment, both the wireless communication device 110 and the computer device 102 support a small computer system interface (SCSI) standard. Thus, the computer device 102 can perform a SCSI command exchange with the wireless communication device 110 via the wired connection, so as to read the compact disc image file from the wireless communication device 110. Moreover, the compact disc image file includes the automatic installation procedure. When the computer device 102 identifies the compact disc image file as a drivable compact disc device, the computer device 102 performs the automatic installation procedure to execute the automatic dial-up connection procedure, so that the computer device 102 is connected to Internet via a wireless dial-up connection and starts to transmit data to Internet and receive data from Internet. The methods of realizing a automatic dial-up connection to Internet from a computer via a wireless communication device will be further described below with reference to FIG. 3 and FIG. 4.

FIG. 3 is a flowchart illustrating a method of realizing an automatic dial-up connection to Internet from a computer via a wireless communication device according to an exemplary embodiment of the invention. Referring to FIG. 3, in the present exemplary embodiment, the automatic dial-up connection method 300 starts with step S302, and proceeds to step S304. In the step S304, a procedure of an automatic dial-up connection to Internet is composed, where the automatic dial-up connection procedure includes a user data. As described above, the user data contains a predetermined legitimate username, a predetermined legitimate password, and a predetermined legitimate dial-up connection option. After the step S304, a step S306 is executed. In the step S306, a compact disc image file is produced according to the automatic dial-up connection procedure. After the step S306, step S308 is executed.

Referring to FIG. 3, in the step S308, the compact disc image file is burned into a wireless communication device 110. The compact disc image file further includes a automatic installation procedure. After the computer device 102 and the wireless communication device 110 establish a wired connection, the automatic installation procedure is performed to execute the automatic dial-up connection procedure, so that the computer device 102 is connected to Internet via a wireless dial-up connection established between the wireless communication network 120 and the wireless communication device 110. The step of burning the compact disc image file into the wireless communication device 110 further includes following steps if a storage hardware device storing the predetermined storage area has a verification area. First, the compact disc image file is burned into a predetermined storage area of the wireless communication device 110, and an error correction code (ECC) is then verified. After that, the user data is stored into a program area within the predetermined storage area. Generally speaking, in the compact disc image file, a 3-byte ECC verification data is generated corresponding to every 256 bytes of data. After the step S308, step S310 is executed.

In the step S310, the computer device 102 and the wireless communication device 110 establish a wired connection. After the step S310, step S312 is executed. In the step S312, the computer device 102 reads the compact disc image file from the wireless communication device 110 and automatically executes the automatic dial-up connection procedure in the compact disc image file by performing the automatic installation procedure, in order to make a dial-up connection to Internet. In the step S314, the computer device 102 is connected to Internet via the dial-up connection established by the wireless communication device 110 (between the wireless communication device 110 and the wireless communication network 120), and starts the data transmission with Internet. After the step S314, step S316 is executed. In the step S316, the automatic dial-up connection method 300 ends.

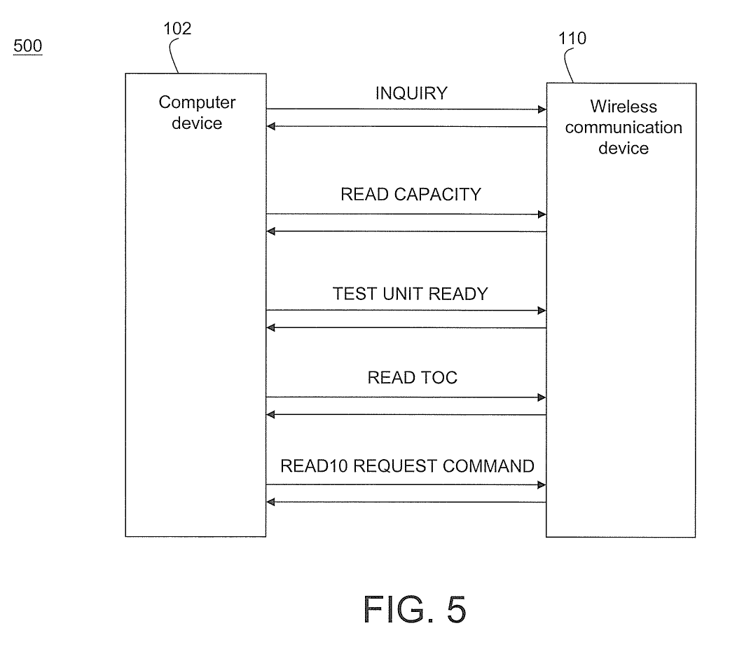

FIG. 4 is a flowchart illustrating a method of realizing an automatic dial-up connection to Internet from a computer via a wireless communication device according to another exemplary embodiment of the invention. Referring to FIG. 4, the steps S402-S410 of the automatic dial-up connection method 400 in the present exemplary embodiment are similar to the steps S302-S310 of the automatic dial-up connection method 300 illustrated in FIG. 3. In step S412 of the automatic dial-up connection method 400, the computer device 102 and the wireless communication device 110 perform a SCSI command exchange via the wired connection, so that the computer device 102 reads the compact disc image file from the wireless communication device 110 through the SCSI command exchange. After the step S412, step S414 is executed. In the step S414, the computer device 102 performs the automatic installation procedure according to the compact disc image file to execute the automatic dial-up connection procedure. After the step S414, step S416 is executed. In the step S416, the computer device 102 is connected to Internet via a wireless dial-up connection established by the wireless communication device 110. After the step S416, step S418 is executed, and the automatic dial-up connection method 400 ends in the step S418. Steps S416-S418 are executed after step the S414, and these steps are similar to the steps S314-S316 of the automatic dial-up connection method 300 therefore will not be described herein. The SCSI command exchange in step S412 performed by the computer device 102 and the wireless communication device 110 will be described below in detail with reference to FIG. 5.

FIG. 5 is a schematic diagram illustrating how a computer and a wireless communication device exchange SCSI commands according to an exemplary embodiment of the invention. Referring to FIG. 5, in the present exemplary embodiment, the computer device 102 and the wireless communication device 110 performs the SCSI command exchange, and a wireless communication network 120 is omitted in FIG. 5 since it is not the focus of the present exemplary embodiment. First, the computer device 102 issues an INQUIRY command to the wireless communication device 110 to inquire at least a peripheral device type of the predetermined storage area in the memory unit 112 of the wireless communication device 110 and determines whether the peripheral device type is a compact disc device, such as a CD-ROM. Then, the computer device 102 receives a response which is issued by the wireless communication device 110 according to the INQUIRY command and issues a READ CAPACITY command to the wireless communication device 110 to inquire at least a block length in bytes of each block in the predetermined storage area in the memory unit 112 of the wireless communication device 110 and the capacity of the storage hardware device. Assuming that the wireless communication device 110 usually responds with the block length as 2,048 bytes when the predetermined storage area of the wireless communication device 110 has been virtually set as a CD-ROM block.

Referring to FIG. 5, in the present exemplary embodiment, after the computer device 102 receives the block length of the predetermined storage area from the wireless communication device 110, the computer device 102 issues a TEST UNIT READY command to the wireless communication device 110 to determine whether a hardware device of the predetermined storage area in the memory unit 112 is ready. After the computer device 102 receives the response of the wireless communication device 110, the computer device 102 issues a READ TOC command to the wireless communication device 110 to obtain related information of optical tracks in the CD-ROM block of the predetermined storage area. A table of contents (TOC) area is usually configured in a CD-ROM area, and a CD-ROM driver software in the computer device 102 reads related information from the TOC area and provides the information to the computer device 102. In the present exemplary embodiment, the actual memory device may be, for example, a NAND FLASH memory such that no TOC area is configured in the predetermined storage area. When the wireless communication device 110 responds to the computer device 102, it is required to send a virtual TOC area information to the computer device 102 according to the procedure and format of SCSI command response.

In the present exemplary embodiment, after receiving the response related to the TOC area from the wireless communication device 110, the computer device 102 issues a READ10 REQUEST command to the wireless communication device 110. The READ10 REQUEST command is a standard SCSI command, and which is mainly adapted for reading data from a compact disc. In the present exemplary embodiment, the computer device 102 uses the READ10 REQUEST command to read the compact disc image file from the wireless communication device 110. The computer device 102 needs to provide at least a logical block address and a transfer length to the wireless communication device 110 in the READ10 REQUEST command. For example, if the storage hardware device configured with the predetermined storage area is a NAND FLASH memory therefore the block length thereof is not 2,048 bytes but 512 bytes or 1,024 bytes, the wireless communication device 110 needs to convert the logical block address and the transfer length.

In another example, if the logical block address provided by the computer device 102 is 17 and the transfer length is 2, the actual block length of the storage hardware device configured with the predetermined storage area is 2,048 bytes, and the wireless communication device 110 provides the content in the compact disc image file corresponding to the 17^{th} and 18^{th} blocks to the computer device 102. However, assuming that the actual block length of the storage hardware device is not 2,048 bytes but 512 bytes, if the logical block address provided by the computer device 102 is still 17 and the transfer length is still 2, the wireless communication device 110 provides the content in the compact disc image file corresponding to the 68^{th} and 75^{th} blocks to the computer device 102 through appropriate conversions. Herein each logical block address is corresponding to 4 of NAND FLASH memory blocks (herein the starting logical block address of the CD-ROM is 17×4=68), and each transfer length is corresponding to 2 of NAND FLASH memory blocks (in the present example, the total transfer length is 2×4=8). Similar conversions can be performed when the storage hardware device has different actual block length (for example, 1,024 bytes).

In the present exemplary embodiment, the commands issued by the computer device 102 to the wireless communication device 110 are all SCSI commands, and the wireless communication device 110 sends corresponding responses (SCSI command responses) to the computer device 102. The SCSI commands, the SCSI command responses, and related technical details can be obtained from the official website (URL: http://www.t10.org/drafts.htm#TOC) of the INCITS T10 technical committee (T10 Committee) of the American National Standard Institute (ANSI).

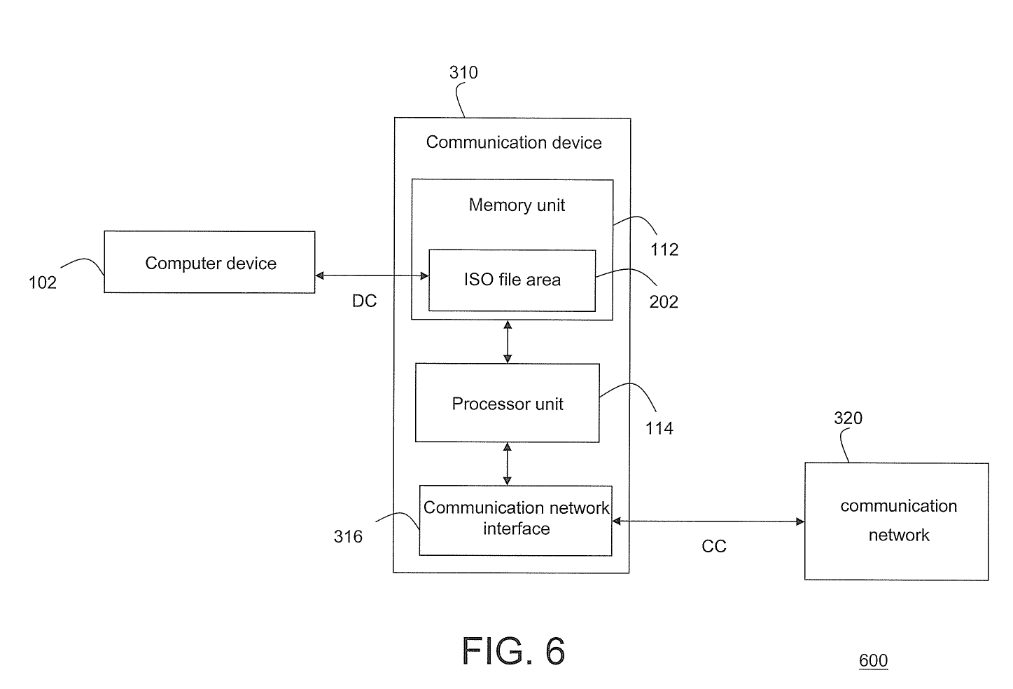

The systems and methods described above are not intended to limit the scope of the invention. FIG. 6 is a schematic block diagram illustrating a method of realizing an automatic dial-up connection to Internet from a computer via a communication device according to another exemplary embodiment of the invention. Referring to FIG. 6, the system 600 in the present exemplary embodiment illustrated in FIG. 6 is similar to the system 200 illustrated in FIG. 2. The only difference between the system 200 and the system 600 is that, in the system 600, the communication device 310 and the computer device 102 establish a wired connection through a SCSI standard interface, and the computer device 102 performs the SCSI command exchange with the communication device 310 via the wired connection to read the compact disc image file from the communication device 310. Besides, the system 600 further includes a communication network interface 316 for establishing a transmission cable connection CC with the communication network 320. In other words, the communication device 310 may be, for example, a modem. In the present exemplary embodiment, the communication network 320 may be, for example, a plain switched telephony network (PSTN). In this case, the communication network interface 316 is a twisted pair cable interface (i.e., a general telephone line interface). In other exemplary embodiments, the communication network 320 may also be, for example, a metropolitan Ethernet, and in this case, the communication network interface 316 is a RJ-45 network cable connector interface.

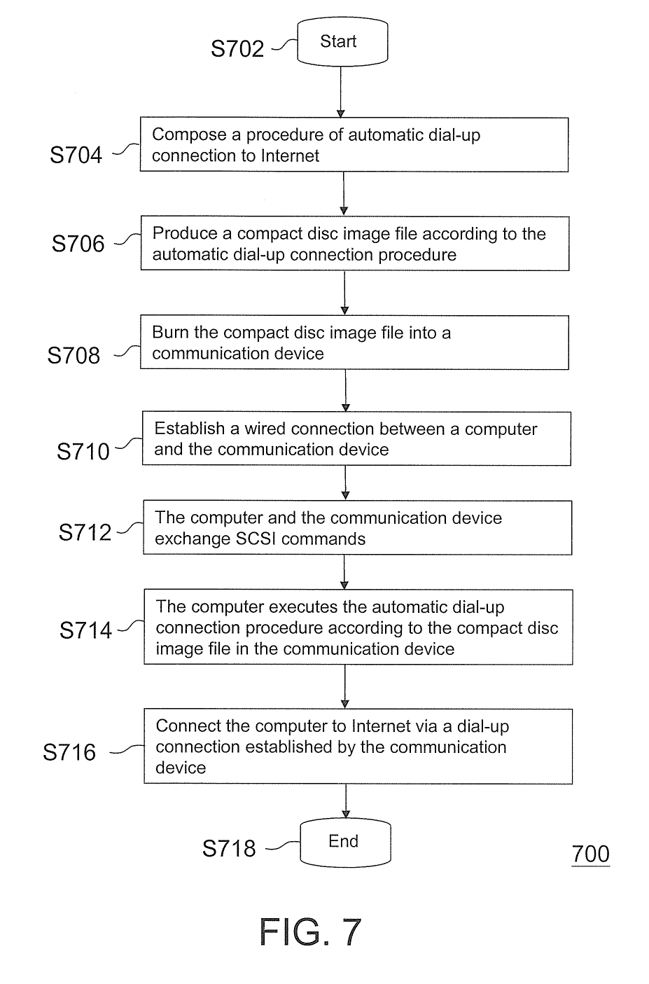

The memory unit 112 in the system 600 includes an ISO file area 202, where the ISO file area 202 includes a compact disc image file. When the computer device 102 identifies the compact disc image file as a drivable compact disc device, the computer device 102 performs an automatic installation procedure in the compact disc image file, and executes an automatic dial-up connection procedure by performing the automatic installation procedure, so that the computer device 102 can be connected to Internet via a wired dial-up connection and start transmitting data to and receiving data from Internet. The automatic dial-up connection procedure of the communication network 320 can be adjusted according to requirements of the communication network 320. However, the detailed configurations and procedures of the automatic dial-up connection procedure will not be described herein. A method of realizing an automatic dial-up connection to Internet from a computer via a communication device will be described below with reference to FIG. 7.

FIG. 7 is a flowchart illustrating a method of realizing an automatic dial-up connection to Internet from a computer via a communication device according to another exemplary embodiment of the invention. Referring to FIG. 4, steps S702-S706 of the automatic dial-up connection method 700 in the present exemplary embodiment are similar to the steps S402-S406 of the automatic dial-up connection method 400 illustrated in FIG. 4. After the step S706 of the automatic dial-up connection method 700, in step S708, the compact disc image file is burned into the communication device 310. After the step S708, step S710 is executed. In the step S710, the computer device 102 and the communication device 310 establish a wired connection. After the step S710, step S712 is executed.

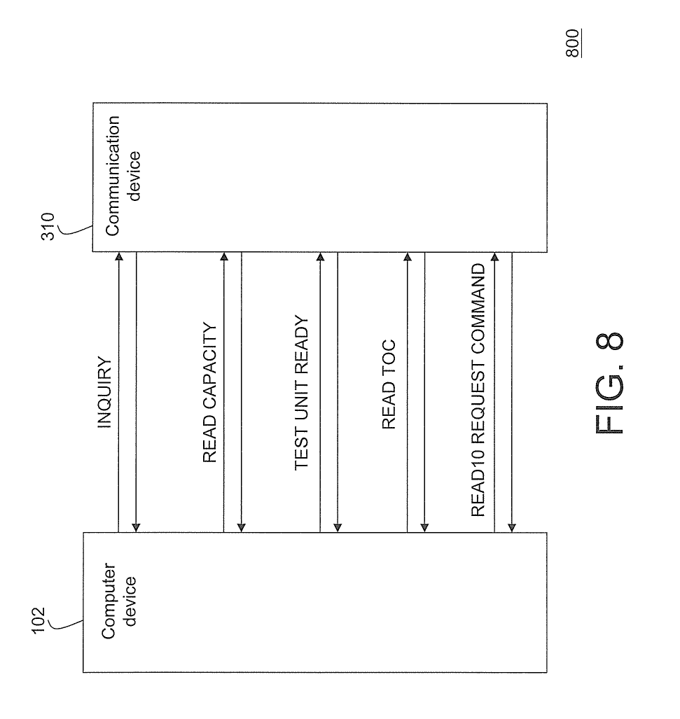

In the step S712, the computer device 102 and the communication device 310 performs a SCSI command exchange via the wired connection so as to read the compact disc image file from the communication device 310. After the step S712, step S714 is executed. In the step S714, the computer device 102 performs an automatic installation procedure according to the compact disc image file, and the computer device 102 executes an automatic dial-up connection procedure by performing the automatic installation procedure so that a dial-up connection is established between the communication device 310 and the communication network 320. After the step S714, step S716 is executed. In the step S716, the computer device 102 is connected to Internet via the dial-up connection established by the communication device 310 and starts transmitting data to and receiving data from Internet. After the step S716, step S718 is executed. In step S718, the automatic dial-up connection method 700 ends. After the method of realizing an automatic dial-up connection to Internet from a computer via a communication device is described, the technical details of the SCSI command exchange executed in step S712 between the computer device 102 and the communication device 310 will be described below with reference to FIG. 8.

FIG. 8 is a schematic diagram illustrating how a computer and a communication device exchange SCSI commands according to another exemplary embodiment of the invention. Referring to FIG. 8, in the present exemplary embodiment, the procedure of the SCSI command exchange executed by the computer device 102 and the communication device 310 is similar to that illustrated in FIG. 5. First, the computer device 102 issues an INQUIRY command to the communication device 310 to inquire the peripheral device type of the predetermined storage area in the memory unit 112 of the communication device 310 and determines whether the peripheral device type is a compact disc device. Then, after the computer device 102 receives a response which is issued by the communication device 310 according to the INQUIRY command, the computer device 102 issues a READ CAPACITY command to the communication device 310 to inquire the block length of the predetermined storage area in the memory unit 112 of the communication device 310 and the capacity of the storage hardware device. After the computer device 102 receives the block length of the predetermined storage area from the communication device 310, the computer device 102 issues a TEST UNIT READY command to the communication device 310 to determine whether the hardware device of the predetermined storage area in the memory unit 112 is ready.

After the computer device 102 receives the response of the communication device 310, the computer device 102 issues a READ TOC command to the communication device 310 to obtain information related to optical tracks within a CD-ROM block of the predetermined storage area. In the present exemplary embodiment, when the actual memory device is, for example, a NAND FLASH memory, no TOC area is configured in the predetermined storage area. When the communication device 310 responds the computer device 102, it sends a virtual TOC area information to the computer device 102 according to the procedure and format of the SCSI command response. In the present exemplary embodiment, after the computer device 102 receives the response related to the TOC area from the communication device 310, the computer device 102 issues a READ10 REQUEST command to the communication device 310 to read data from the compact disc (i.e., the computer device 102 uses the READ10 REQUEST command to read the compact disc image file from the communication device 310). In the present exemplary embodiment, the commands issued by the computer device 102 to the communication device 310 are all SCSI commands, and the communication device 110 issues corresponding responses (i.e., SCSI command responses) to the computer device 102.

In summary, according to exemplary embodiments of the invention, a method of realizing an automatic dial-up connection to Internet from a computer and a communication device using the same are provided. A compact disc image file is virtually composed in a memory area of a communication device, where the compact disc image file includes an automatic installation procedure and an automatic dial-up connection procedure. After the computer and the communication device establish a wired connection and complete a handshaking procedure, the computer performs an automatic installation procedure in the compact disc image file to accomplish an automatic dial-up connection functionality. Thereby, the complexity of configuring a computer to be connected to Internet via a dial-up connection through a communication device is lowered. Accordingly, when a user needs using Internet, the user does not need manually setting up a dial-up connection procedure in the computer.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method of realizing an automatic dial-up connection to Internet from a computer, suitable for connecting the computer to Internet through a communication device, the method comprising:
composing a procedure of automatic dial-up connection to Internet, wherein the automatic dial-up connection procedure comprises a user data;
producing a compact disc image file according to the automatic dial-up connection procedure, said compact disc image file comprising an automatic installation procedure;
burning the compact disc image file into the communication device; and
when the communication device is connected to the computer, the computer executing the automatic dial-up connection procedure by performing the automatic installation procedure, in order to make a dial-up connection to Internet.

2. The method according to claim 1, wherein the user data comprises:
a predetermined legitimate username;
a predetermined legitimate password; and
a predetermined legitimate dial-up connection option, wherein when executing the automatic dial-up connection procedure, the communication device provides the predetermined legitimate username, the predetermined legitimate password, and the predetermined legitimate dial-up connection option to Internet to perform an authentication procedure.

3. The method according to claim 1, wherein the step of producing the compact disc image file comprises:
converting the automatic dial-up connection procedure into a compact disc
data storage structure, wherein the compact disc data storage structure conforms to an ISO9660 standard.

4. The method according to claim 3, wherein the step of burning the compact disc image file into the communication device comprises:
burning the compact disc image file into a predetermined storage area of the communication device, and further verifying an error correction code if a storage hardware device configured with the predetermined storage area comprises a verification area; and
storing the user data into a program area of the predetermined storage area.

5. The method according to claim 1 further comprising:
establishing a wired connection between the computer and the communication device;
the computer reading the compact disc image file from the communication device and executing the automatic dial-up connection procedure according to the compact disc image file to make a dial-up connection to Internet; and
the computer performing a data transmission with Internet via the dial-up connection.

6. The method according to claim 5, wherein the computer establishes the wired connection with the communication device through a universal serial bus (USB) interface, and the computer performs a wired data transmission with the communication device by USB interface enumeration.

7. The method according to claim 5, wherein both the communication device and the computer support a small computer system interface (SCSI) standard.

8. The method according to claim 7, wherein the step of reading the compact disc image file from the communication device and executing the automatic dial-up connection procedure comprises:
executing a SCSI command exchange between the computer and the communication device via the wired connection;
the computer reading the compact disc image file from the communication device through the SCSI command exchange; and
the computer executing the automatic dial-up connection procedure by performing the automatic installation procedure to make a dial-up connection to Internet.

9. The method according to claim 4, wherein the storage hardware device configured with the predetermined storage area comprises a FLASH memory device.

10. The method according to claim 1, wherein the communication device comprises a modem, a mobile phone, and a wireless data network card.

11. The method according to claim 1, wherein the automatic dial-up connection procedure comprises:
a first file, wherein a filename extension of the first file comprises “.exe”;
a second file, wherein a filename extension of the second file comprises “.dat”; and
a third file comprising a file having a filename of “autorun.inf”, and when the computer performs the automatic installation procedure, the computer calls the first file according to the third file.

12. A communication device, suitable for realizing an automatic dial-up connection to Internet from a computer via the communication device to connect the computer to Internet, the communication device comprising:
a communication network interface, for establishing a dial-up connection to Internet;
a wired connection interface, for establishing a wired connection with the computer; and
a memory unit, for storing a compact disc image file, wherein the compact disc image file comprises an automatic installation procedure, and when the communication device is connected to the computer, the computer executes an automatic dial-up connection procedure by performing the automatic installation procedure, in order to make a dial-up connection to Internet.

13. The communication device according to claim 12, wherein the compact disc image file is burned into the communication device, and the automatic dial-up connection procedure comprises a user data.

14. The communication device according to claim 13, wherein the user data comprises:
a predetermined legitimate username;
a predetermined legitimate password; and
a predetermined legitimate dial-up connection option, wherein when executing the automatic dial-up connection procedure, the communication device provides the predetermined legitimate username, the predetermined legitimate password, and the predetermined legitimate dial-up connection option to Internet to perform an authentication procedure.

15. The communication device according to claim 12, wherein the automatic dial-up connection procedure is converted into a compact disc data storage structure, wherein the compact disc data storage structure conform to an ISO9660 standard.

16. The communication device according to claim 12, wherein both the communication device and the computer support a SCSI standard.

17. The communication device according to claim 16, wherein
the communication device and the computer execute a SCSI command exchange via the wired connection;
the computer reads the compact disc image file from the communication device through the SCSI command exchange; and
the computer executes the automatic dial-up connection procedure by performing the automatic installation procedure to make a dial-up connection to Internet.

18. The communication device according to claim 12, wherein the wired connection interface comprises a USB interface, the computer establishes the wired connection with the communication device through the USB interface, and the computer performs a wired data transmission with the communication device by USB interface enumeration.

19. The communication device according to claim 12 comprising a modem, a mobile phone, and a wireless data network card.

20. The communication device according to claim 12, wherein the automatic dial-up connection procedure comprises:
a first file, wherein a filename extension of the first file comprises “.exe”;
a second file, wherein a filename extension of the second file comprises “.dat”; and
a third file comprising a file having a filename of “autorun.inf”, and when the computer performs the automatic installation procedure, the computer calls the first file according to the third file.
